(19) United States
(12) Patent Application Publication
(10) Pub. No.: US 2018/0065121 A1
(43) Pub. Date: Mar. 8, 2018

(54) Seed Sorting Machine

(71) Applicants: Pin-Hui Chen, Taipei City (TW); Tien-Yang CHENG, Taipei City (TW); Michael John FURST, Elmore, VT (US)

(72) Inventors: Pin-Hui Chen, Taipei City (TW); Tien-Yang CHENG, Taipei City (TW); Michael John FURST, Elmore, VT (US)

(21) Appl. No.: 15/256,960

(22) Filed: Sep. 6, 2016

(51) Int. Cl. B02B 7/02; B02B 3/04; B07B 1/12

(52) U.S. Cl. CPC B02B 7/02; B07B 1/12; B02B 3/045

(57) ABSTRACT

A seed sorting machine contains a feeding area, a plurality of filtration units, a classification assembly, multiple guiding assemblies, a delivery unit, and at least one pressing rod. Each filtration unit includes multiple holding trays, a plurality of first partitions, and each holding tray has a filtering hole. The classification assembly includes a classifying tray, multiple guide sheets, and a plurality of outlets. Each guiding assembly includes a holder and multiple ribs, wherein between any two adjacent of the multiple ribs is defined a slot which corresponds to each of the plurality of outlets. The delivery unit includes a base on which multiple V-shaped grooves and multiple second partitions are arranged. Each pressing rod includes a plurality of rollers and multiple trenches, wherein each of the multiple trenches is defined between any two adjacent of the multiple trenches and corresponds to each of the multiple V-shaped grooves.

### BACKGROUND OF THE INVENTION

### Field of the Invention

The present invention relates to a sorting machine, and more particularly to a seed sorting machine which classifies seeds and crushes shells of the seeds quickly.

### Description of the Prior Art

Nuts (such as a variety of seeds, e.g. watermelon seeds) with shells are popular, for example, the seeds are mixed with seasoning in processing stage so as to enhance their flavor. However, nutlets of the seeds are covered by shells, so they cannot be mixed with the seasoning completely, and the shells cannot be crushed carefully.

To overcome above-mentioned problems, a shell crusher is applied to crush the shells of the seeds, for example, the shell crusher accommodates the seeds and is manually pressed so as to crush the shells of the seeds, thus removing nutlets from the shell crusher. Nevertheless, such operation is troublesome.

To enhance germination of the seeds, the shells of the seeds are crushed slightly so that the seeds absorb water and nutrient substances quickly, but the shell crusher damages the seeds badly, so the seeds cannot be grown well.

The present invention has arisen to mitigate and/or obviate the afore-described disadvantages.

### SUMMARY OF THE INVENTION

The primary objective of the present invention is to provide a seed sorting machine which delivers seeds and crushes shells of the seeds quickly and easily at low noises and failure rate.

Further objective of the present invention is to provide a seed sorting machine which does not crush nutlets of the seeds and mixes the nutlets with seasoning completely.

Another objective of the present invention is to provide a seed sorting machine which facilities breeding and germination.

To obtain above-mentioned objectives, a seed sorting machine provided by the present invention contains: a feeding area, a plurality of filtration units, a classification assembly, multiple guiding assemblies, a delivery unit, and at least one pressing rod.

The plurality of filtration units are obliquely disposed below the feeding area, wherein each of the plurality of filtration units includes multiple holding trays and a plurality of first partitions, any two adjacent of which are mounted on two sides of each of the multiple holding trays, and said each holding tray has a filtering hole formed between any two adjacent of the plurality of first partitions.

The classification assembly is mounted below the plurality of filtration units, and the classification assembly includes a classifying tray, multiple guide sheets obliquely defined thereon and located below filtering holes of the plurality of filtration units respectively, and a plurality of outlets arranged on the classifying tray and located on distal ends of the multiple guide sheets thereof individually.

The multiple guiding assemblies are obliquely arranged below the classification assembly, and each of the multiple guiding assemblies includes a holder and multiple ribs formed on the holder, wherein between any two adjacent of the multiple ribs is defined a slot which corresponds to each of the plurality of outlets.

The delivery unit includes a base on which multiple V-shaped grooves and multiple second partitions are arranged, wherein between any two adjacent of the multiple second partitions is defined each of the multiple V-shaped grooves, and the slot corresponds to one or more of the multiple V-shaped.

Each of the at least one pressing rod includes a plurality of rollers and multiple trenches, wherein each of the multiple trenches is defined between any two adjacent of the multiple trenches and corresponds to said each V-shaped grooves.

Preferably, said each holding tray has a stepped portion arranged on a bottom thereof and configured to define the filtering hole, and the stepped portion has multiple peripheral sides which define a plurality of widths of the filtering hole with each of the plurality of first partitions so as to classify seeds of various sizes.

Preferably, multiple first connection shafts are inserted through the plurality of first partitions so as to fix said each filtration unit.

Preferably, the feeding area includes a plurality of tilted plates crisscross arranged therein so as to separate a first space from a second space.

Preferably, the multiple trenches have depths respectively.

Preferably, a motor is configured to drive the at least one pressing rod.

Preferably, a first of two opposite of the multiple second partitions is higher than a second of the two opposite second partitions, and some of the multiple second partitions higher than the others of the multiple second partitions are connected together by ways of two second connection shafts.

### BRIEF DESCRIPTION OF THE DRAWINGS

FIG. 1 is a perspective view showing the assembly of a seed sorting machine according to a preferred embodiment of the present invention.

FIG. 2 is a perspective view showing the exploded components of the seed sorting machine according to the preferred embodiment of the present invention.

FIG. 3 is a side plane view showing the assembly of a filtration unit of the seed sorting machine according to the preferred embodiment of the present invention.

FIG. 4 is a perspective view showing the operation of the seed sorting machine according to the preferred embodiment of the present invention.

FIG. 4A is a side plane view showing the operation of the seed sorting machine according to the preferred embodiment of the present invention.

FIG. 5 is a side plane view showing the operation of a delivery unit of the seed sorting machine according to the preferred embodiment of the present invention.

FIG. 6 is another side plane view showing the operation of the seed sorting machine according to the preferred embodiment of the present invention.

FIG. 7 is a side plane view showing the assembly of at least one pressing rod of the seed sorting machine according to the preferred embodiment of the present invention.

FIG. 8 is a side plane view showing the operation of the at least one pressing rod of the seed sorting machine according to the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

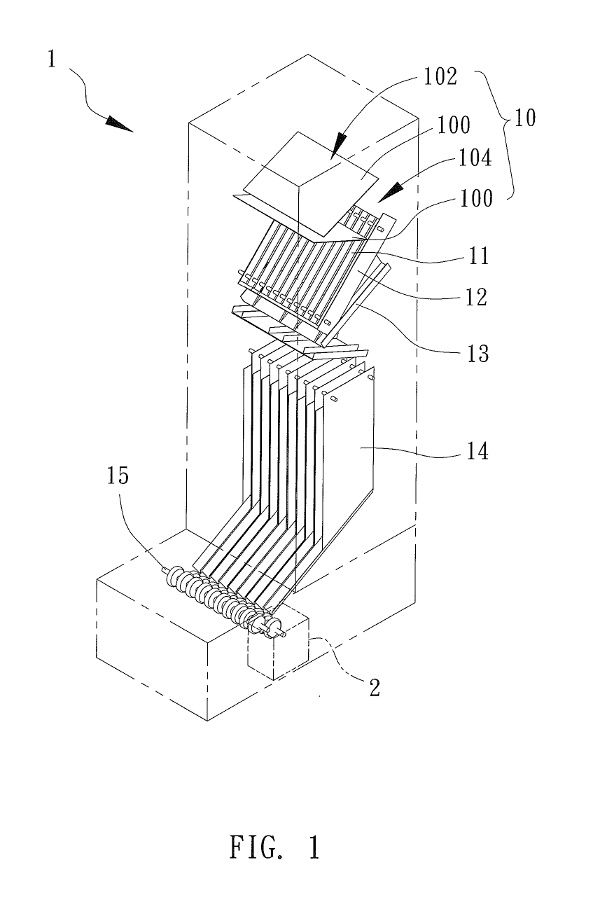

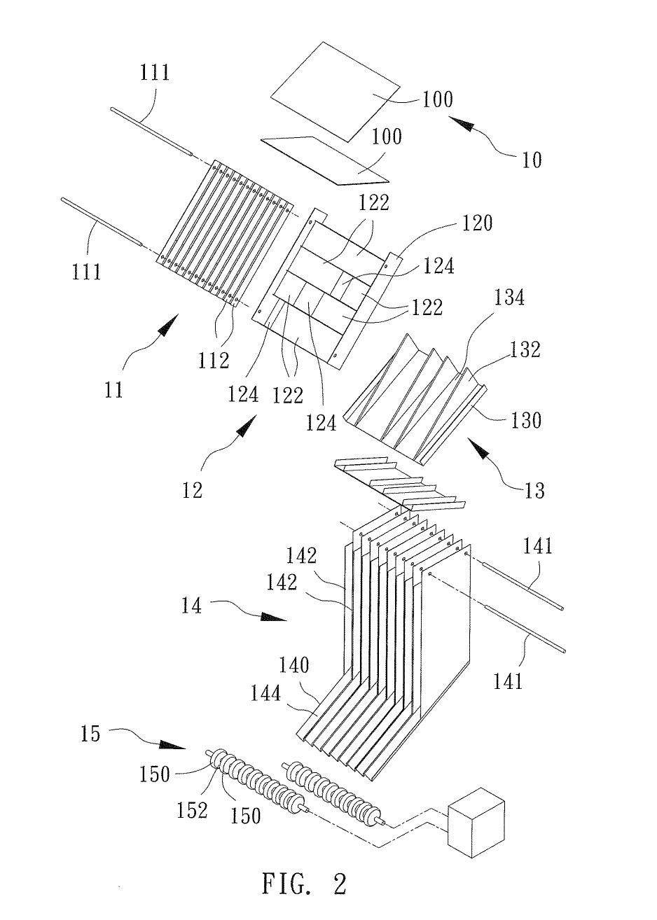

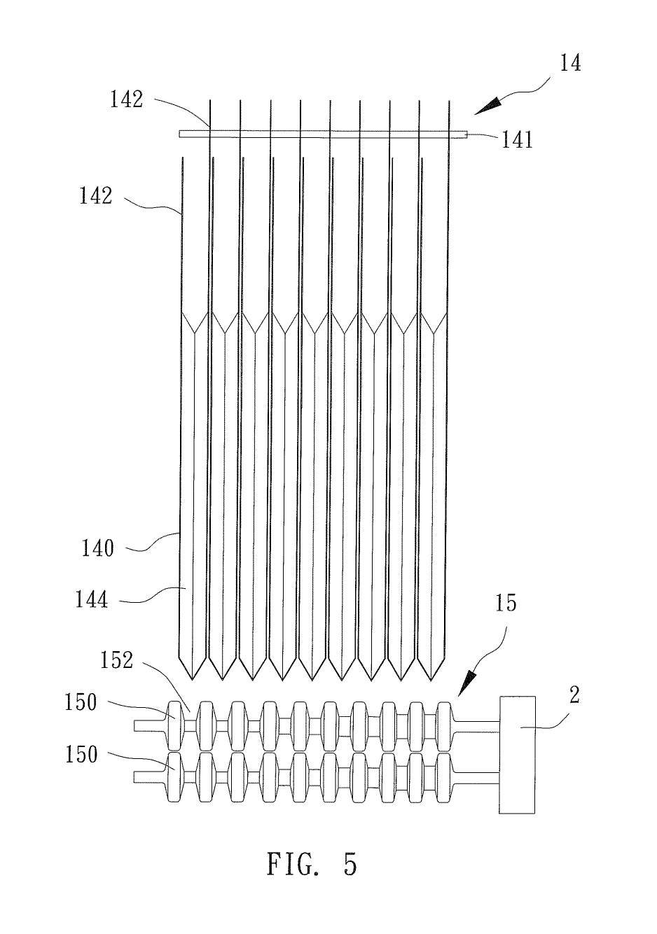

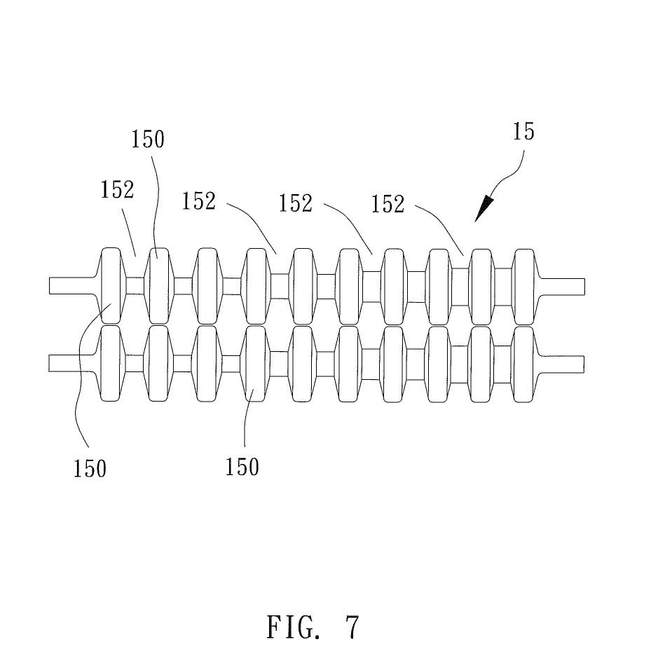

With reference to FIGS. 1-3, 5 and 7, a seed sorting machine 1 according to a preferred embodiment of the present invention comprises: a feeding area 10, a plurality of filtration units 11, a classification assembly 12, multiple guiding assemblies 13, a delivery unit 14, and at least one pressing rod 15.

The feeding area 10 includes a plurality of tilted plates 100 crisscross arranged therein so as to separate a first space 102 from a second space 104.

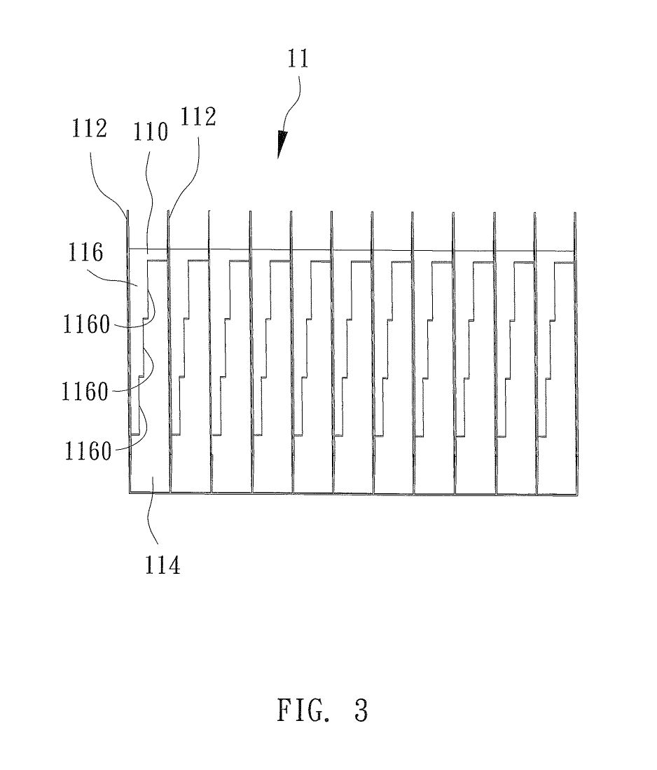

Each of the plurality of filtration units 11 is obliquely disposed below the feeding area 10 and includes multiple holding trays 110, a plurality of first partitions 112, any two adjacent of which are mounted on two sides of each of the multiple holding trays 110, and said each holding tray 110 has a filtering hole 114 formed between any two adjacent of the plurality of first partitions 112, wherein two first connection shafts 111 are inserted through the plurality of first partitions 112 so as to fix said each filtration unit 11. Referring to FIG. 3, said each holding tray 110 has a stepped portion 116 arranged on a bottom thereof and configured to define the filtering hole 114, and the stepped portion 116 has multiple peripheral sides 1160 which define a plurality of widths of the filtering hole 114 with each of the plurality of first partitions 112 so as to classify nuts (such as a variety of seeds, e.g. watermelon seeds) of various sizes quickly.

The classification assembly 12 is mounted below the plurality of filtration units 11, and the classification assembly 12 includes a classifying tray 120, multiple guide sheets 122 obliquely defined thereon and located below filtering holes 114 of the plurality of filtration units 11 respectively, and a plurality of outlets 124 arranged on the classifying tray 120 and located on distal ends of the multiple guide sheets 122 thereof individually.

Each of the multiple guiding assemblies 13 is obliquely arranged below the classification assembly 12, and said each guiding assembly 13 includes a holder 130 and multiple ribs 132 formed on the holder 130, wherein between any two adjacent of the multiple ribs 132 is defined a slot 134 corresponding to each of the plurality of outlets 124.

Thereby, the multiple guide sheets 122 of the classification assembly 12 are located below the filtering holes 114 respectively so that the seeds are classified and drop on the multiple guide sheets 122 based on their sizes, and the seeds are guided to the plurality of outlets 124 via the multiple guide sheets 122, wherein said each outlet 124 corresponds to the slot 134 between said any two adjacent ribs 132. In this embodiment, the filtering hole 114 of said each holding tray 110 has four widths, and each of the four widths of the filtering hole 114 is equal to each of four distances between each of four peripheral sides 1160 and said each first partition 112, hence the seeds individually drop on the multiple guide sheets 122 via the four widths of the filtering hole 114 based on their sizes, and the seeds drop into the slot 134 via the plurality of outlets 124 along the multiple guide sheets 122.

The delivery unit 14 includes a base 140 on which multiple V-shaped grooves 144 and multiple second partitions 142 are arranged, wherein between any two adjacent of the multiple second partitions 142 is defined each of the multiple V-shaped grooves 144, wherein the slot 134 corresponds to one or more of the multiple V-shaped grooves 144, a first of two opposite of the multiple second partitions 142 is higher than a second of the two opposite second partitions 142, and some of the multiple second partitions 142 higher than the others of the multiple second partitions 142 are connected together by ways of two second connection shafts 141. Thereby, the multiple V-shaped grooves 144 of the base 140 accommodate the seeds from the slot 134.

Each of the at least one pressing rod 15 is located beside open segments of the multiple V-shaped grooves 144 and includes a plurality of rollers 150 and multiple trenches 152, wherein each of the multiple trenches 152 is defined between any two adjacent of the multiple trenches 152 and corresponds to said each V-shaped grooves 144. In this embodiment, two pressing rods 15 are configured to crush shells of the seeds, wherein depths of the multiple trenches 152 correspond to the seeds of the various sizes respectively so that the shells of the seeds are crushed by the multiple trenches 152, wherein the depths of the multiple trenches 152 correspond to the multiple holding trays 110 of various sizes. Preferably, the seeds drop into the multiple trenches 152 of various depths from the slot 134 between said any two adjacent ribs 132 after being classified, hence the seeds are arranged and delivered based on their sizes by using the slot 134.

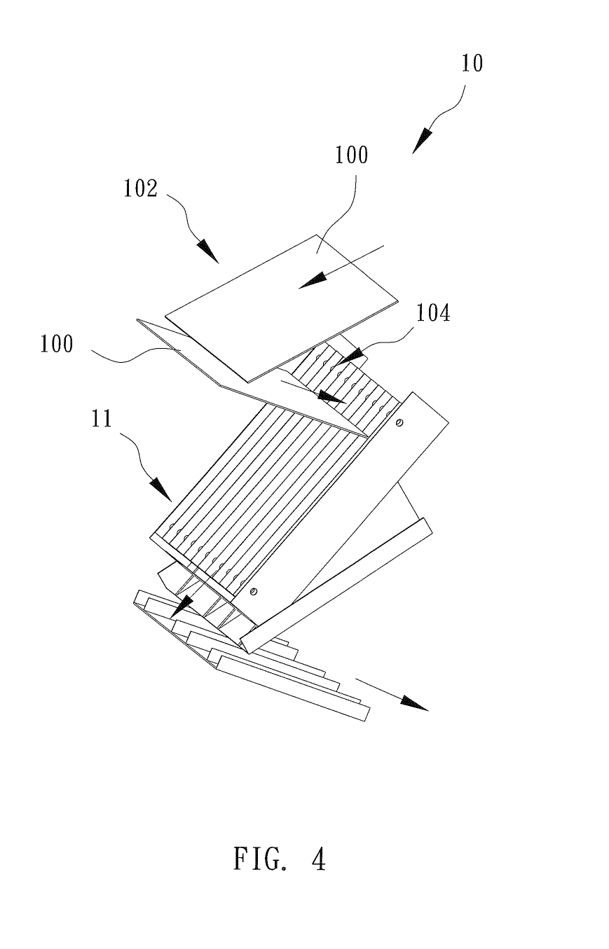

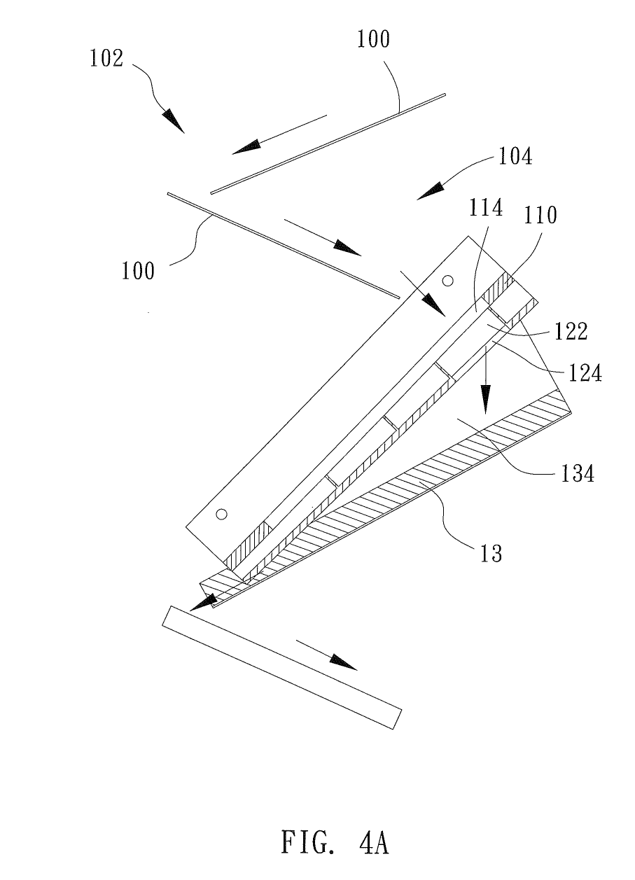

As shown in FIGS. 4 and 4A, the seed sorting machine 1 is used to classify the seeds and to crush the shells of the seeds, for example, the seeds are fed into the feeding area 10 and drop into the plurality of filtration units 11 flatly by way of the plurality of tilted plates 100 via the first space 102 and the second space 104, wherein the seeds are classified based on their sizes by using the filtering holes 114 of the multiple holding trays 110 (as illustrated in FIG. 3). In this embodiment, the four widths of the filtering hole 114 are 9 mm, 9.3 mm-10 mm, 10 mm-11 mm, and 11 mm-12 mm individually. Accordingly, the seeds drop on said each guiding assembly 13 via the filtering holes 114, each of the multiple guide sheets 122 is located below the filtering hole 114, and each of the plurality of outlets 124 is arranged on each of the distal ends of the multiple guide sheets 122, such that four filtering holes 114 correspond to four outlets 124, and one of the four outlets 124 represents one of the seeds in one size. In addition, said each outlet 124 corresponds to one of the multiple guiding assemblies 13, and the slot 134 guides the seeds in the same size to the delivery unit 14.

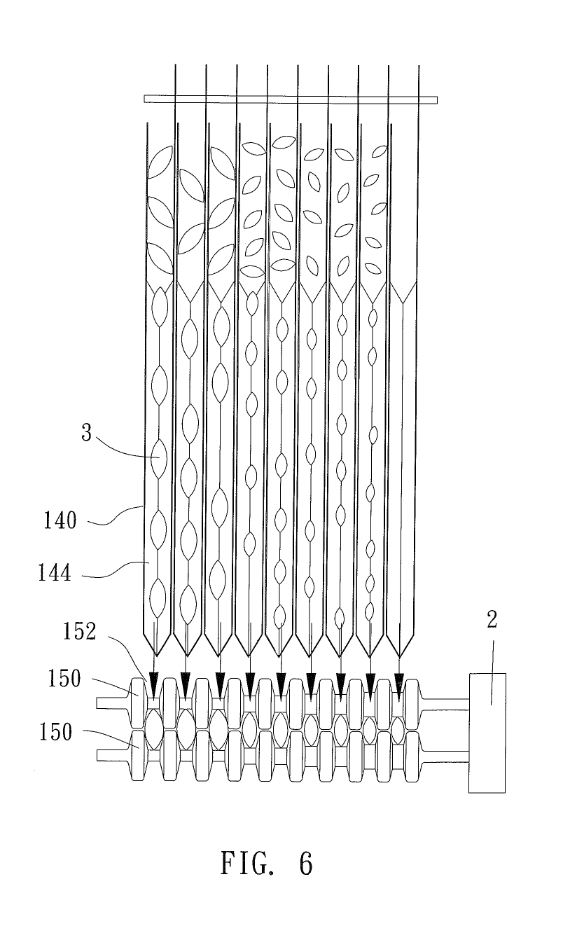

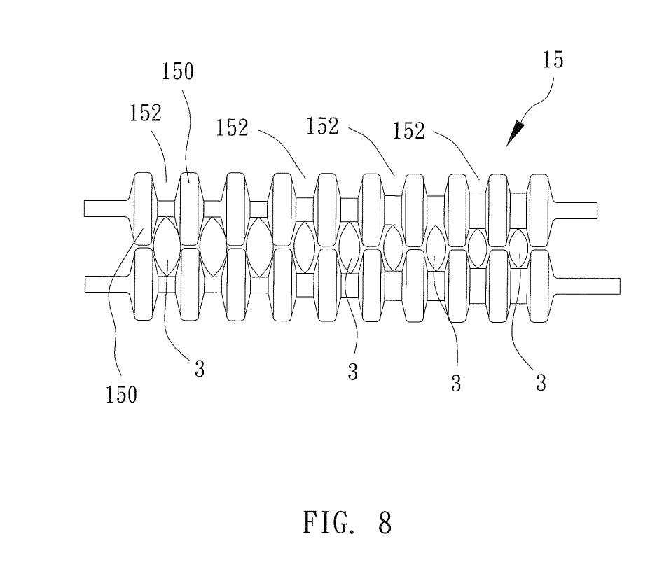

Referring to FIGS. 6 and 8, the shells of the seeds 3 are crushed by the at least one pressing rod 15 after being positioned through the delivery unit 14, wherein the at least one pressing rod 15 is driven by a motor 2, and one of the at least one pressing rod 15 is configured to hold the seeds 3 and has the multiple trenches 152 of various depths so as to correspond to the seeds 3 of the various sizes. For example, some of the multiple trenches 152 of larger depths accommodate some of the seeds 3 of larger sizes, and the others of the multiple trenches 152 of smaller depths house the other of the seeds 3 of smaller sizes. Thereby, the at least one pressing rod 15 crushes the shells of the seeds 3 of the various sizes by way of the multiple trenches 152 of the various depths respectively.

The seed sorting machine of the present invention delivers the seeds and crushes the shells of the seeds quickly and easily at low noises and failure rate. In addition, nutlets of the seeds are not crushed by the seed sorting machine and mix with seasoning completely, and the seed sorting machine facilities breeding and germination.

While we have shown and described various embodiments in accordance with the present invention, it is clear to those skilled in the art that further embodiments may be made without departing from the scope of the present invention.

What is claimed is:

1. A seed sorting machine comprising:
a feeding area;
a plurality of filtration units obliquely disposed below the feeding area, each of the plurality of filtration units including multiple holding trays and a plurality of first partitions, any two adjacent of which are mounted on two sides of each of the multiple holding trays, and said each holding tray having a filtering hole formed between any two adjacent of the plurality of first partitions;
a classification assembly mounted below the plurality of filtration units, and the classification assembly including a classifying tray, multiple guide sheets obliquely defined thereon and located below filtering holes of the plurality of filtration units respectively, and a plurality of outlets arranged on the classifying tray and located on distal ends of the multiple guide sheets thereof individually;
multiple guiding assemblies obliquely arranged below the classification assembly, and each of the multiple guiding assemblies including a holder and multiple ribs formed on the holder, wherein between any two adjacent of the multiple ribs is defined a slot which corresponds to each of the plurality of outlets;
a delivery unit including a base on which multiple V-shaped grooves and multiple second partitions are arranged, wherein between any two adjacent of the multiple second partitions is defined each of the multiple V-shaped grooves, and the slot corresponds to one or more of the multiple V-shaped; and
at least one pressing rod, each of the at least one pressing rod including a plurality of rollers and multiple trenches, wherein each of the multiple trenches is defined between any two adjacent of the multiple trenches and corresponds to said each V-shaped grooves.

2. The seed sorting machine as claimed in claim 1, wherein said each holding tray has a stepped portion arranged on a bottom thereof and configured to define the filtering hole, and the stepped portion has multiple peripheral sides which define a plurality of widths of the filtering hole with each of the plurality of first partitions so as to classify seeds of various sizes.

3. The seed sorting machine as claimed in claim 2 further comprising multiple first connection shafts inserted through the plurality of first partitions so as to fix said each filtration unit.

4. The seed sorting machine as claimed in claim 1, wherein the feeding area includes a plurality of tilted plates crisscross arranged therein so as to separate a first space from a second space.

5. The seed sorting machine as claimed in claim 1, wherein the multiple trenches have different depths respectively.

6. The seed sorting machine as claimed in claim 1, a motor configured to drive the at least one pressing rod.

7. The seed sorting machine as claimed in claim 1, wherein a first of two opposite of the multiple second partitions is higher than a second of the two opposite second partitions, and some of the multiple second partitions higher than the others of the multiple second partitions are connected together by ways of two second connection shafts.
